(19) United States
(12) Patent Application Publication
(10) Pub. No.: US 2010/0077898 A1
(43) Pub. Date: Apr. 1, 2010

(54) ADJUSTABLE POMMEL HANDLE FOR POWER TOOL

(76) Inventors: David Mitchell Smith, Simpsonville, SC (US); Russell Carlson, East Providence, RI (US); Robert Gautsch, Belton, SC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/242,190

(22) Filed: Sep. 30, 2008

(51) Int. Cl. B26D 1/14; B25G 1/10

(52) U.S. Cl. 83/469; 16/430

(57) ABSTRACT

An adjustable handle for a power tool is disclosed. The adjustable handle may be rotated about the longitudinal axis of the handle to a position desired by the user and locked into the desired position by a locking member. The adjustable handle may be positioned into one of a plurality of predetermined handle positions.

The invention is related to the field of hand held power tools. In particular the invention is related to an adjustable handle for a hand held circular saw.

### BACKGROUND

Hand held power tools are typically designed with handle features to allow a user to conveniently grasp and manipulate the power tool. For example, known circular saws may contain two handles that may be grasped by each hand of a user during a cutting operation. A circular saw may have a first handle proximal to the rear of the circular saw that may comprise a power trigger to activate the circular saw. The circular saw may also have a second handle forward of the first handle to allow a user additional control over the circular saw during use. In what may be known as a “right-handed” circular saw, the user may grasp the first handle with his or her right hand and grasp the second handle with his or her left hand during use. The second handle may be a knob or elongated handle fixed to the outer housing of the circular saw.

Hand held power tools may be adjusted to different orientations during use or may be operated in several different orientations. For example, some circular saws allow users to perform “bevel” cuts. In such an operation, the circular saw may be rotated at an angle with respect to a typically horizontal base to perform a cut at, for example, a 30° or 45° angle. Although, the orientation of operation of the power tool may change, the handles remain at fixed angles with respect to the power tool housing. This can cause the user to grasp the power tool at angles awkward to a user. The varying angles of operation of the hand held power tools can cause discomfort and place wrist stress on the user. The fixed angle of the handles can also interfere with the line of sight with the work piece during operation when the power tool is in some orientations.

Thus, the present invention is directed to providing an adjustable handle for use with hand held power tools that can be easily adjusted without disrupting a work procedure. The present invention is also directed to an adjustable handle that optimizes a user's line of sight and grip position, that promotes comfort and that reduces wrist stresses.

### BRIEF SUMMARY

In one aspect of the invention, a power tool has a housing having a motor for driving a tool. The power tool also has a first handle attached to the housing which has an elongated body defining a longitudinal axis. The elongated body is capable of rotation about the longitudinal axis. The first handle also has a locking member wherein said locking member has internal threads and is operable to restrict rotational motion of the first handle. The power tool further comprises a second handle attached to the housing.

In another aspect of the invention a method of adjusting a handle for a power tool is provided. In one step of the method a power tool is provided having a housing and a first handle and a second handle connected to the housing. In another step the first handle is rotated about a longitudinal axis of the handle to a desired position. In another step the first handle is locked in the desired position with a locking member. In yet another step, the first handle and second handle are grasped during operation of the power tool.

In yet another aspect of the invention, an adjustable handle for a power tool has an elongated body defining a longitudinal axis. The elongated body further has a male selector member and a female selector member having a recess. The male selector member and female selector member are operable to engage each other and are rotatable with respect to each other about the longitudinal axis. The adjustable handle for a power tool also has a grip section connected with an end of the elongated body and a locking member rotatable with respect to the elongated body and operable to rotate between a first position and a second position. When the locking member is in a first position the male selector member and the female selector are operable to be rotated with respect to each other. When the locking member is in a second position the male selector member and the female selector are releasably fixed with respect to each other.

Advantages of the present invention will become more apparent to those skilled in the art from the following description of the preferred embodiments of the invention which have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a perspective view of a power tool having an adjustable handle according to a preferred embodiment of the present invention;

FIG. 2 is a partial perspective view of the adjustable handle according to a preferred embodiment of the present invention;

FIG. 3A is a perspective view of the elongated member according to a preferred embodiment of the present invention;

FIG. 3B is an exploded view of the adjustable handle with an elongated member according to a preferred embodiment of the present invention;

FIG. 4 is a perspective view of the adjustable handle according to a preferred embodiment of the present invention; and

FIGS. 5A-5B are perspective views of the adjustable handle and power tool housing according to a preferred embodiment of the present invention.

### DETAILED DESCRIPTION OF THE DRAWINGS AND THE PRESENTLY PREFERRED EMBODIMENTS

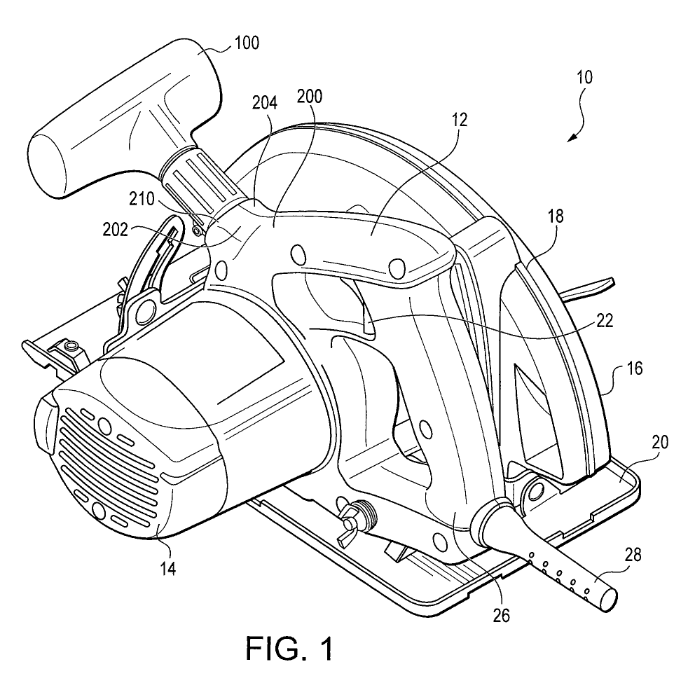

A portable power tool 10 is shown in FIG. 1. Although a portable circular saw is shown in FIG. 1, the present invention may be used on various power tools such as a sander, polisher or grinder. The portable power tool 10 has a housing 12 enclosing an electric motor 14. A tool 16, such as a saw blade, is attached to a rotary output member of the motor 14. In the embodiment of FIG. 1, the upper portion of the tool 16 is covered by a stationary guard 18 which is attached to the housing 12. In one embodiment, a base 20 is pivotally attached to the housing 12 which permits the tool 16 to be inclined relative to the workpiece during a cutting operation. The housing 12 also includes a primary handle 26 which also incorporates a trigger or motor switch 22. The housing 12 also includes a handle mounting section 200 to which an adjustable handle 100 is attached. The adjustable handle 100 is mounted forward of primary handle 26 as illustrated in FIG. 1 and positioned away from primary handle 26 to allow a user to conveniently and comfortably manipulate the power tool 10. Typically when the power tool 10 is in use, the operator will place his or her right hand on the primary handle 26 with the operator's index finger adjacent the trigger and the user's left hand will be positioned on the adjustable handle 100. The forward position of the adjustable handle 100 relative to primary handle 26 enables the user to comfortably guide the saw, when in use, as well as to comfortably lift the saw into and out of engagement with a workpiece.

In the illustrated embodiment, electrical power is provided to the motor by means of an electrical cord 28 having an electrical plug attachable to a conventional household electrical outlet. Alternatively, a battery powered version of the saw could be made using a rechargeable battery pack and a DC electric motor.

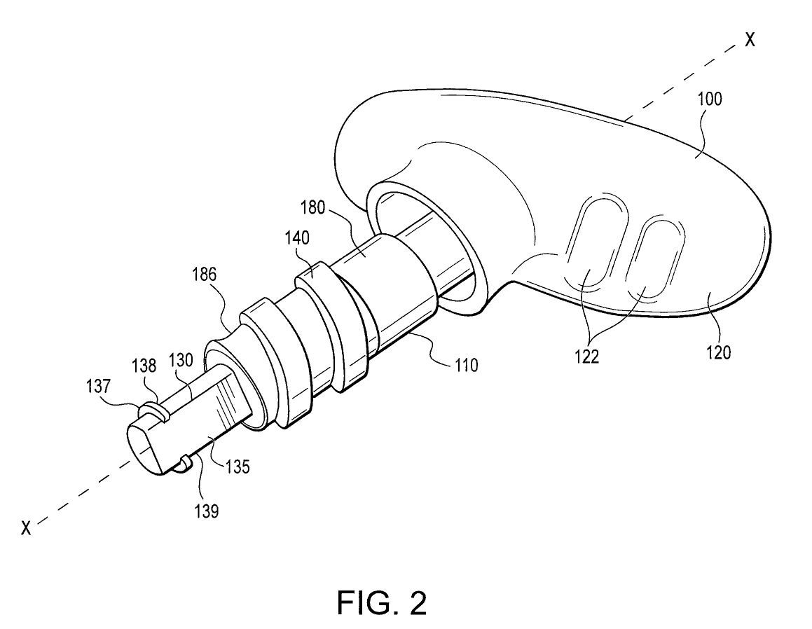

The adjustable handle 100 according to one embodiment is partially shown in more detail in FIG. 2. The adjustable handle 100 includes an elongated body 110 defining a longitudinal axis x, a grip section 120 and a pivot portion 130. In the embodiment of FIG. 2, the elongated body 110 is substantially cylindrical and defines external threads 140. In one preferred embodiment, the thread profile is an Acme thread profile, however, other suitable profiles may also be used. The adjustable handle 100 also includes grip section 120 connected with an end of the elongated body 110 for providing a convenient interface between the user and the adjustable handle 100 during operation. The grip section 120 can be formed integrally with the elongated body 110 or can be separate from the elongated body 110 and can be made of a soft cover for comfortable handling. The grip section 120 can also contain a plurality of grooves 122 operable to accommodate a user's fingers.

The adjustable handle 100 also has a pivot portion 130 connected with the end opposite the end of the elongated body 110 connected with the grip section 120. The pivot portion 130 engages the housing through an opening 210 in the handle mounting portion 200 of the housing. The pivot portion 130 is preferably substantially cylindrical, but also defines a substantially planar mating surface 135. The pivot portion 130 also has a ring member 137 that projects radially from the pivot portion 130. The ring member 137 further defines a stop surface 138. The ring member 137 may be formed integrally with the pivot portion 130, or the ring member 137 may be a separate piece fixedly attached to the pivot portion 130.

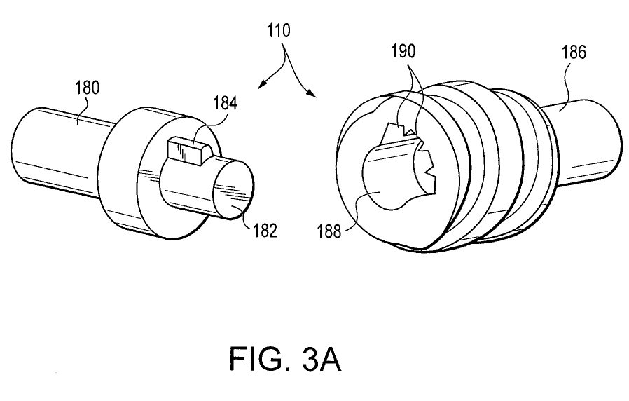

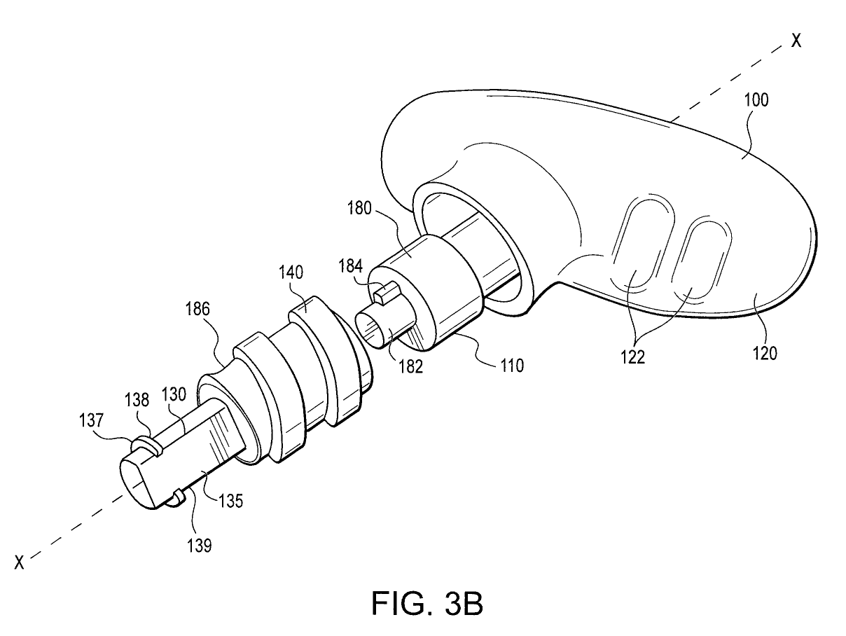

In one embodiment, the elongated body 110 provides the user a manner to adjust the adjustable handle 100 into one of a plurality of predefined positions. In the embodiment of FIGS. 3A-3B, the elongated body 110 comprises a male selector member 180 and a female selector member 186. The male selector member 180 defines a longitudinal shaft 182 having a selector projection 184. The female selector member 186 defines a recess 188 having a plurality of selector recesses 190. The longitudinal shaft 182 is operable to engage the recess 188 such that the male selector member 180 is rotatable with respect to the female selector member 186. The selector projection 184 is operable to engage one of the plurality of the selector recesses 190 and may be moved into adjacent selector recesses 190 upon rotation of the male selector member 180 with respect to the female selector member 186. Rotation of the selector projection 184 into the different selector recesses 190 corresponds to placement of the adjustable handle 100 into one of a plurality of predetermined handle positions. The user is therefore provided tactile feedback as he or she moves the adjustable handle 100 into each of the predefined adjustable handle positions.

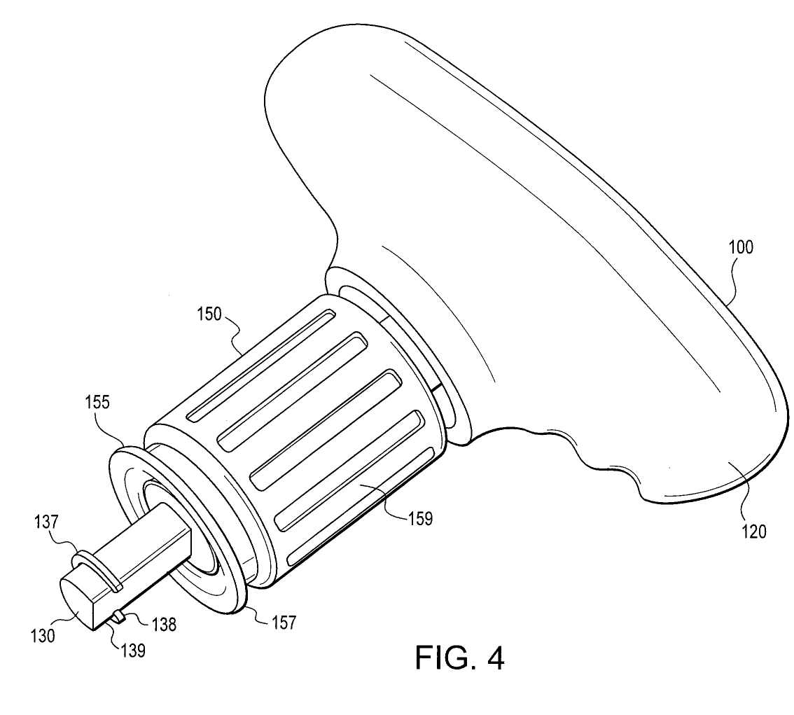

The adjustable handle 100 also defines a locking member 150. In the embodiment of FIG. 4, the locking member 150 is substantially cylindrically shaped and is concentric to the elongated body 110. The locking member 150 defines internal threading that mate with the external threading 140 of the elongated body 110. The locking member 150 further defines a disk portion 155 having a radial projection 157 from the locking member 150. The radial projection 157 is operable to engage a channel 212 defined by the handle mounting portion 200 of the housing. The locking member 150 may also define external grip features 159 to provide improved manipulation of the locking member 150 by the user when the user turns the locking member 150.

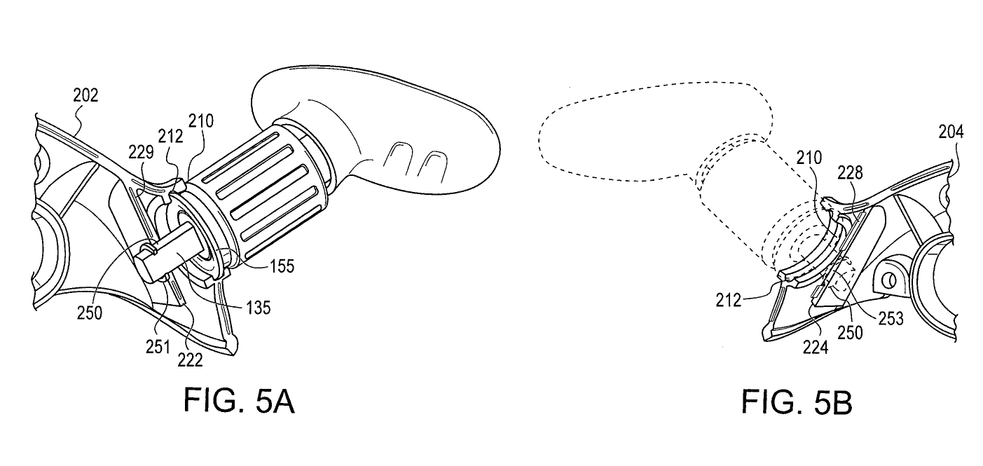

The handle mounting portion 200 of the housing defines an opening 210 to accommodate the adjustable handle. In the embodiment of FIGS. 5A-5B, the handle mounting portion is comprised of two shell halves 202, 204 that engage each other to secure the adjustable handle 100 within the housing 12. When assembled together, the shell halves 202, 204 define a channel 212 that engages the disk portion 155 of the locking member 150 such that the locking member 150 may rotate within the channel 212, but is restricted from moving axially with respect to the longitudinal axis x of the elongated portion 110. The shell halves 202, 204 of the handle mounting portion 200 also comprise ribs 222, 224 that define a D-shaped notched opening 250 for engaging the pivot portion 130 of the adjustable handle 100. In this embodiment, the notched opening 250 defines a cylindrical surface 251 and a substantially planar surface 253. The substantially planar surface 253 is sized to engage the substantially planar mating surface 135 of the pivot portion. In this way, when handle adjustment is desired, the engagement of the planar surfaces 135, 253 prevent rotation of the female selector member 186. Thus, the male selector member 180 may be rotated with respect to the female selector member 186 without causing rotation of the female selector member 186. In one embodiment, the ribs 222, 224 may also interface with each other via an elongated tongue-and-groove configuration. In the embodiment of FIGS. 5A-5B, the rib 222 contains at least one elongated groove 229, and the rib 224 contains at least one corresponding tongue 228.

In operation of one embodiment of the adjustable handle 100 of the power tool, the user rotates the adjustable handle 100 around the longitudinal axis x to place the adjustable handle 100 in a desired position. In one embodiment, the user places the adjustable handle 100 into one of a plurality of predetermined positions corresponding to the different positions of the selector recesses 190 of the recess 188. The user then rotates the locking collar 150 from a first, release position to a second, lock position to lock the adjustable handle 100 in place. Rotation of the locking collar 150 causes the internal threads of the locking collar 150 to engage the external threads 140 of the elongated body 110, creating an axial force along the longitudinal axis x. In the embodiment of FIGS. 2-3B, the locking member 150 is restricted from axial motion through the interface between the disk portion 155 and channel 212. The elongated body 110 travels axially until the grip section 120 contacts the locking member 150, which restricts further axial motion. The resulting frictional forces caused by tightening the locking collar 150 restrict rotational movement of the adjustable handle 100. The adjustable handle 100 is thus releasably locked in a desired position. When a user desires to reorient the adjustable handle 100, he or she need only rotate the locking member 150 in the opposite direction to loosen the locking member 150. The adjustable handle 100 may then be reoriented to a desired position.

In another embodiment, the female selector member 186 need not have a plurality of selector recesses 190. In this embodiment, the selector projection 184 can rotate within the recess 188 without being required to engage selector recesses 190 that correspond to predetermined handle positions. The user may thus select the position of the adjustable handle 100 according to a desired position and then lock the adjustable handle 100 with the locking member according to the procedures described above.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof. For example, while specific reference has been made to the use of a circular saw, the devices and methods in accordance with principles of the present invention are equally applicable to other hand held power tools.

1. A power tool comprising:
a housing having a motor for driving a tool;
a first handle attached to the housing, the first handle having an elongated body defining a longitudinal axis, the elongated body capable of rotation about the longitudinal axis, and a locking member wherein said locking member has internal threads and is operable to restrict rotational motion of the first handle; and
a second handle attached to the housing.

2. The power tool of claim 1 wherein the first handle may be rotated into one of a plurality of predefined positions.

3. The power tool of claim 1 wherein the elongated body defines threads that engage the internal threads of the locking member.

4. The power tool of claim 1 wherein the housing is comprised of a first shell and a second shell, the first shell and second shell each defining at least a portion of an opening for receiving the first handle.

5. The power tool of claim 1 wherein the elongated body is further comprised of a male selector member having a longitudinal shaft and a female selector member having a recess, the male selector member and a female selector member being operable to engage each other and being rotatable with respect to each other.

6. The power tool of claim 5 wherein the recess of the female selector member comprises a plurality of selector recesses corresponding to a plurality of predetermined first handle positions.

7. The power tool of claim 5 wherein the female selector member includes a substantially planar surface that engages a substantially planar surface of the housing to restrict rotation of the female selector member.

8. The power tool of claim 1 wherein the power tool is a circular saw.

9. A method of adjusting a handle for a power tool comprising the steps of:
providing a power tool having a housing and a first handle and a second handle connected to the housing;
rotating the first handle about a longitudinal axis of the handle to a desired position;
locking the first handle in the desired position with a locking member; and
grasping the first handle and second handle during operation of the power tool.

10. The method of claim 10 wherein the locking member and first handle have corresponding threads and wherein locking the first handle with the locking member comprises rotating the locking member in a first direction around the first handle.

11. The method of claim 10 wherein the first handle is rotated to position the first handle in one of a plurality of predetermined positions.

12. The method of claim 11 wherein the first handle has a plurality of recesses that correspond to a plurality of predetermined positions.

13. The method of claim 10 wherein the second handle is fixedly connected with the housing.

14. The method of claim 9 wherein the first handle is further comprised of a male selector member having a longitudinal shaft and a female selector member having a recess, the male selector member and a female selector member engage each other and rotate with respect to each other when the first handle is rotated about a longitudinal axis of the handle to the desired position.

15. The method of claim 9 further comprising the step of unlocking the first handle after operation the power tool and reorienting the first handle.

16. The method of claim 10 further comprising the step of rotating the locking member about the first handle in a second direction to unlock the locking member.

17. An adjustable handle for a power tool comprising:
an elongated body defining a longitudinal axis, the elongated body further comprising a male selector member and a female selector member having a recess, the male selector member and female selector member being operable to engage each other and being rotatable with respect to each other about the longitudinal axis;
a grip section connected with an end of the elongated body;
a locking member rotatable with respect to the elongated body and operable to rotate between a first position and a second position wherein when the locking member is in a first position the male selector member and the female selector are operable to be rotated with respect to each other and when the locking member is in a second position the male selector member and the female selector are releasably fixed with respect to each other.

18. The adjustable handle of claim 17 wherein rotation of the grip section causes rotation of the male selector member when the locking member is in the first position.

19. The adjustable handle of claim 17 wherein the grip section is operable to be positioned into one of a plurality of predetermined positions.

20. The adjustable handle of claim 17 wherein the recess of the female selector member defines a plurality of selector recesses that correspond to a plurality of predetermined handle positions.

21. The adjustable handle of claim 20 wherein the male selector member comprises a selector projection to engage at least one of the plurality of selector recesses.
